(19) United States
(12) Patent Application Publication
(10) Pub. No.: US 2009/0001897 A1
(43) Pub. Date: Jan. 1, 2009

(54) Display Device

(76) Inventors: Toshifumi Ozaki, Koganei (JP); Masahisa Tsukahara, Fujisawa (JP); Junichi Yokoyama, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/127,026

(22) Filed: May 27, 2008

(30) Foreign Application Priority Data
Jun. 25, 2007 (JP) 2007-166254

(51) Int. Cl. G09G 3/30

(52) U.S. Cl. 315/169.3

(57) ABSTRACT

In the case of applying the ABL control to a display device having electron emitters disposed in a matrix, voltage drop caused by the scan line resistance is corrected, thereby displaying a preferable image without a smear. A high voltage load current limiting section for calculating drive voltage alteration data based on a high voltage load current detection signal from a high voltage load current detection section, and a scan voltage correction section for calculating a scan voltage based on the drive voltage alteration data are provided, thus the scan voltage in accordance with the high voltage load current detection signal is output to a scan line selection circuit. Further, a voltage drop correction section is provided to subtract the drive voltage alteration data from the drive voltage data obtained from image data input thereto, and signal voltage data is calculated and is output to the signal line drive circuit 15.

### CLAIM OF PRIORITY

The present application claims priority from Japanese Application JP 2007-166254 filed on Jun. 25, 2007, the content of which is hereby incorporated by reference into this application.

### BACKGROUND OF THE INVENTION

1. Technical Field

The present invention relates in particular to a display device using a multi-electron source having electron emission elements disposed in a matrix.

2. Related Art

In recent years, a light emitting matrix display, which has electron sources at intersections between electrode line groups perpendicular to each other, controls the amplitude or the period of the voltage applied to each of the electron sources to control the amount of electrons emitted from the electron source, and makes the emitted electrons converge with a high voltage to irradiate a fluorescent material, has attracted attention.

As the electron source, there can be cited what uses a field-emission cathode, what uses carbon nanotube, what uses a surface-conduction electron-emitter, and so on. Although in the display of this kind, the greater the amount of the emitted electrons is, the higher the brightness becomes, application of the automatic brightness limiter (ABL) function for limiting the brightness is commonly proposed for the purpose of reduction of heat generation of the display panel and the power consumption of the display, and protection of the high-voltage circuit. The ABL function is for performing an operation of reducing the amount of the electrons to be emitted in the case in which the average luminance exceeds a preset level.

As the related art, in JP-A-2003-255884 (Document 1) there is described a display device having a correction circuit 304 for executing a correction process on image data for correcting the variation in display brightness caused by the influence of the voltage drop generated by at least the resistance components of the line wires, and brightness control circuits 306A, 306B, 306C for controlling the display brightness based on the luminance data of image information in the display device having display elements 301 disposed in a matrix and driven via a plurality of line wires and a plurality of column wires, a scan circuit 302 for scanning the line wires, and a modulation circuit 303 for supplying the column wires with modulation signals based on the image data.

Further, in JP-A-2001-51645 (Document 2), there is described an image display device having a display panel 6 including an electron generation section having electron emitters disposed in a matrix, a pulse width modulation circuit 4 having a constant current source control circuit 41 and for driving the display panel 6, a high-voltage power supply circuit 8 for supplying the display panel 6 with a high voltage, a current detection circuit 81 for detecting the amount of the current Ia flowing from the high-voltage power supply circuit 8 to the display panel 6, an I-V conversion circuit 9 for converting the current Ia into a voltage Vb to be input into the constant current source control circuit 41, and thereby controlling the amount of the constant current supplied from the constant current source control circuit 41 to the electron emitters of the display panel 6 in accordance with the voltage Vb.

Further, in JP-A-2003-153123 (Document 3), there is described the fact that a display panel, luminance averaging means, scene switching detection means, and brightness control means are provided, wherein the scene switching detection means judges whether the scene is switched or not based on the frame difference, the secondary differentiation value, or the like of the average luminance, and makes the change in display brightness quicker when the scene has been switched.

Further, in JP-A-2003-233344 (Document 4), there is described the fact that there are provided correction image data calculation means 14 for calculating the correction image data for correcting the influence of the voltage drop caused by the resistance components of at least the line wires and scanning means with respect to the image data, amplitude adjusting means for adjusting the amplitude of the correction image data Dₒᵤₜ so that the amplitude of the correction image data Dₒᵤₜ corresponds to the input range of modulating means 8, and the modulating means 8 having the correction image data thus adjusted in the amplitude as the input and for outputting the modulation signals on the column wires.

### SUMMARY OF THE INVENTION

In the case in which the brightness reduction method using the ABL function is applied, the drive current of the electron emitter becomes different from the case without the ABL operation, and consequently, the review of the smear correction amount (the correction amount for correcting the brightness gradient or the brightness steps in accordance with the voltage drop caused by the scan line resistance) becomes necessary. In other words, the smear correction caused by the scan line resistance is a correction for every pixel, and when the pixel drive current is varied by the ABL control, the smear correction is required to be executed on the pixel drive current thus varied.

In the related art described in Document 1, as modulating means for driving the column wires, although the technology related to the pulse width modulation circuit is disclosed, no technology related to the amplitude modulation circuit is disclosed. Further, the average luminance necessary for the ABL control is obtained from the image data. Still further, in the related art described in Documents 2, 3, and 4, no technology related to the smear correction in the ABL operation is disclosed.

An object of the present invention is to provide a display device capable of displaying a preferable image without a smear in the display device having the ABL function.

In order for achieving the object described above, the present invention is provided with a high-voltage load current limiting section to vary the selection voltage to be applied to the scan electrode of the scan line, and further, calculates the voltage drop correction amount caused by the scan line resistance and the resistance of the scan electrode selection section in accordance with the amount of the variation of the selection voltage, thereby making the smear correction amount appropriate. Specifically, it is realized using the following measures.

The display device includes a scan line selection section for applying a selection voltage to the scan lines, a scan voltage correction section for correcting a scan voltage to be supplied to the scan line selection section, a voltage drop correction section for calculating an influence of the voltage drop caused by at least one of a resistance of the scan line and a resistance of the scan line selection section, a signal line drive section for driving the signal lines based on output data from the voltage drop correction section, a high voltage generation section for collecting the electrons emitted from the electron emitters to irradiate the fluorescent material, a high voltage load current detection section for detecting a high voltage load current of the high voltage generation section, and a high voltage load current limiting section for limiting the high voltage load current based on a high voltage load current detection result from the high voltage load current detection section, the high-voltage load current limiting section includes a current reduction rate calculation section for calculating a current reduction rate at which a current flowing through the electron emitters is reduced in accordance with the high voltage load current detection result, and a drive voltage alteration amount calculating section for calculating drive voltage alteration data in accordance with the current reduction rate, the scan voltage correction section outputs the scan voltage based on the drive voltage alteration data to the scan line selection section, and the voltage drop correction section outputs the output data obtained by calculating the voltage drop correction amount based on the drive voltage alteration data to the signal line drive section.

Further, a subtracting section for subtracting the drive voltage alteration data form drive voltage data generated from image data input to thereto is provided, and the voltage drop correction amount is calculated using the output result of the subtracting section.

In the display device according to the present invention, even in the case in which the variation in the current flowing through the electron emitter is caused in accordance with the ABL operation, the preferable processing of the smear correction in that condition can be executed. Therefore, the preferable display device without a smear can be realized.

### BRIEF DESCRIPTION OF THE DRAWINGS

FIG. 1 is a configuration diagram of a display device according to the present invention.

FIG. 2 is a characteristic chart of the voltage-current characteristic of an electron emitter.

FIG. 3 is a schematic configuration diagram of a display panel.

FIG. 4 is a circuit diagram of an equivalent circuit of a scan line.

### DESCRIPTION OF THE PREFERRED EMBODIMENTS

Hereinafter, an embodiment of the present invention will be described with reference to the accompanying drawings.

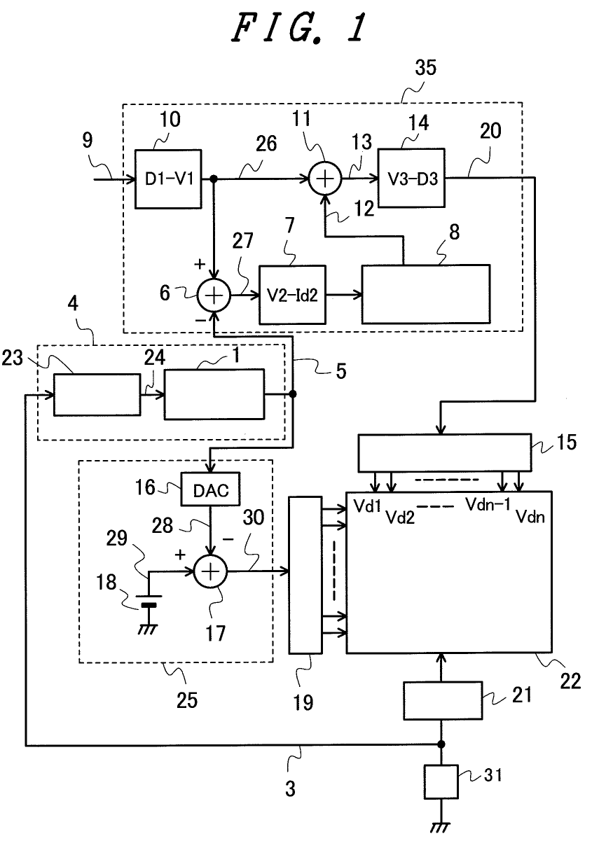

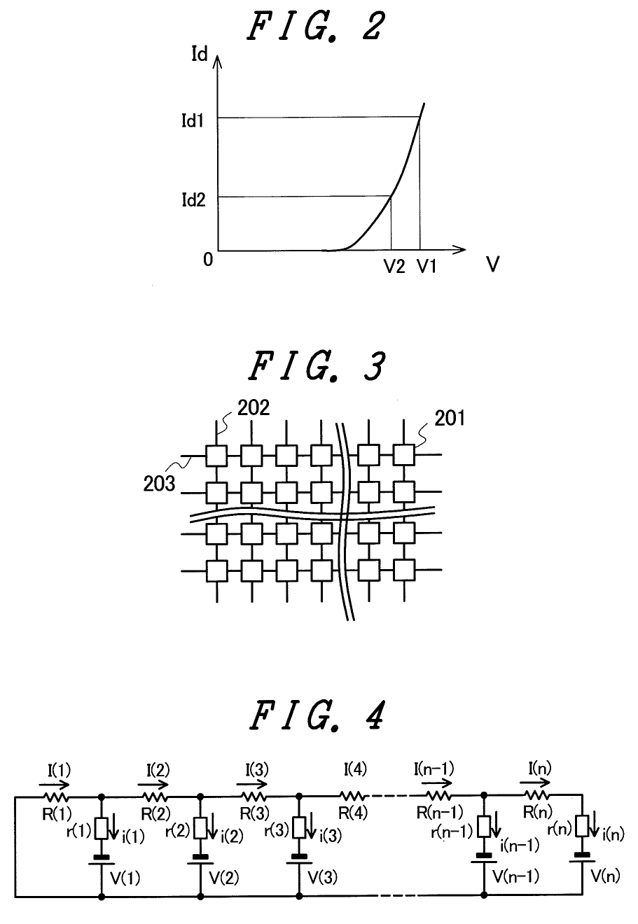

Firstly, FIG. 2 shows the characteristic of a current I_{d} flowing through an electron emitter in accordance with a drive voltage V applied between the both ends of an electron source in the case in which a thin film electron source is used as the electron emitter, which is a constituent of the display panel 22 shown in FIG. 1. FIG. 2 shows a characteristic in which I_{d} is extremely small in the low voltage region of the drive voltage V, and the current I_{d} flowing through the electron emitter increases exponentially as the drive voltage V grows. In the present embodiment, it is assumed that the current flows through the electron emitter and the electrons are emitted from the electron emitter to a space when a positive voltage is applied to the scan line as the drive voltage V between the signal line and the scan line.

FIG. 1 is a configuration diagram of a display device according to the present invention. In FIG. 1, a signal line drive circuit 15 for driving each of the signal lines of the display panel 22 with the signal voltage is an amplitude modulation drive circuit for controlling the current of the electron emitter by the output voltage level thereof. Further, a scan line selection circuit 19 for applying the selection voltage to the scan line of the display panel 22 is composed of a group of switches connected respectively to the scan lines, and performs selection operation of the scan line. In the present embodiment, the display panel 22 is driven so that the selection voltage becomes higher than the signal voltage, and at the same time, the selection voltage is lowered, thereby making the high voltage load current limitation and the voltage drop correction appropriate.

The high voltage circuit 21 applies a high voltage to an anode panel of the display panel 22 coated with a fluorescent material to make the electric field be generated between the electron emitter and the florescent material. A high voltage load current detection element 31 is connected to the high voltage circuit 21 as the high voltage load current detection section, and the high voltage circuit 21 outputs the high voltage load current detection signal 3 corresponding to the value of the high voltage load current.

A current reduction rate calculation circuit 23 calculates and then outputs the current reduction rate (0<α≦1) 24 for reducing the current flowing through the electron emitter using the high voltage load current detection signal 3. A drive voltage alteration amount calculation circuit 1 generates drive voltage alteration data 5 using the current reduction rate 24. The drive voltage alteration amount calculation circuit 1 and the current reduction rate calculation circuit 23 form a high voltage load current limiting section 4.

The drive voltage alteration data 5 calculated by the high voltage load current limiting section 4 is input into an adder-subtracter 6 and a digital-analog converter (DAC) 16. The DAC 16 converts the drive voltage alteration data 5 into an analog voltage to generate a selection voltage alteration voltage (ΔV_{H}) 28. An adder-subtracter 17 subtracts the selection voltage alteration voltage (ΔV_{H}) 28 from a selection reference voltage (V_{H}), which is an output voltage of a selection reference voltage source 18, to output a scan voltage 30 (V_{H}−ΔV_{H}). Here, the selection reference voltage 29 is the selection voltage in the image display with a small high voltage load current value. Specifically, in the case in which the high voltage load current value is smaller than a high voltage load current setting value set previously, the selection voltage alteration voltage 28, the output of the DAC 16, is 0 V. When the high voltage load current exceeds the high voltage load current setting value, the selection voltage alteration voltage 28 is increased, thus the scan voltage 30, which is the output of the adder-subtracter 17, is changed downward to lower the display panel drive voltage. As a result, the current of the electron emitter is reduced, thereby the ABL operation is performed so that the amount of electrons to be emitted, namely the high voltage load current, does not exceed the high voltage load current setting value. The DAC 16, the adder-subtracter 17, and the selection reference voltage source 18 form a scan voltage correction section 25.

Then, input image data processing during the ABL operation will be explained. The image data 9 input thereto is input into an image data-to-drive voltage data conversion circuit (D₁−V₁ conversion circuit) 10. Using the image data 9, the D₁−V₁ conversion circuit 10 generates drive voltage data (V₁ shown in FIG. 2) 26 for the case in which the scan line voltage drop correction and the ABL control are not executed.

The adder-subtracter 6 executes a process of subtracting the drive voltage alteration data 5 from the drive voltage data 26 to generate drive voltage data (V₂ shown in FIG. 2) 27. The drive voltage data 27 corresponds to the voltage to be applied to the electron emitter during the ABL control operation. Further, the drive voltage data 27 is the data differing from the drive voltage data 26 in the direction along which the drive voltage is lowered.

A drive voltage data-to-current data conversion circuit (V₂−I_{d2} conversion circuit) 7 executes the conversion process from the drive voltage data 27 into the current flowing through each of the electron emitters using the drive voltage data 27 to generate the current data I_{d2} of each of the electron emitters.

A voltage drop amount calculation circuit 8 executes a product-sum calculation process using the current data I_{d2} and the scan line resistance value per pixel R to obtain voltage drop amount data (ΔV) 12 in each of the electron emitters.

An adder 11 adds the drive voltage data 26 and the voltage drop amount data 12 with each other to obtain differential voltage data (panel drive voltage data V₃) 13 between the selection voltage and the signal voltage with the voltage drop amount in mind.

A panel drive voltage data-to-signal voltage data conversion circuit (V₃-D₃ conversion circuit) 14 executes the process for converting the panel drive voltage data 13 into signal voltage data 20, which determines the output voltage of the signal line drive circuit 15.

The adder-subtracter 6, the drive voltage data-to-current data conversion circuit 7, the voltage drop amount calculation circuit 8, the image data-to-drive voltage data conversion circuit 10, the adder 11, and the panel drive voltage data-to-signal voltage data conversion circuit 14 form a voltage drop correction section 35.

Based on the signal voltage data 20 from the voltage drop correction section 35, the signal line drive circuit 15 uses a decoder built therein to output signal voltages V_{d1} through V_{dn} as analog signals.

As described above, in the case in which the drive voltage is varied in accordance with the ABL operation, the value of the current flowing through the electron emitter is obtained from the drive voltage alteration amount, and the voltage drop amount owing to the scan line resistance can accurately be calculated based on the current value.

The calculation method of the voltage drop amount of the scan line resistance will be explained with reference to FIGS. 3 and 4. In FIG. 3, the cathode panel opposed to the anode panel of the display panel 22 shown in FIG. 1 is provided with the electron emitters 201 disposed in a matrix configuring respective pixels. The electron emitters 201 arranged in a vertical direction are connected to the signal line 202, and the electron emitters 201 arranged in a horizontal direction are connected to the scan line 203.

FIG. 4 is an equivalent circuit in which one of the scan lines and the electron emitters connected to that scan line shown in FIG. 3 are modeled. In FIG. 4, it is assumed that the number of pixels arranged in the horizontal direction is n, the scan line resistances of the respective pixels are R(1) through R(n), equivalent resistances of the electron emitters are r(1) through r(n), the currents flowing through the respective electron emitters are i(1) through i(n), and the drive voltages, which are the differential voltages between the application voltage to the scan line and the application voltages to the signal lines, are V(1) through V(n). On the drive voltages V(1) through V(n), the amplitude modulation is executed using the signal line drive circuit 15 shown in FIG. 1 to control the currents flowing through the electron emitters, thereby realizing the brightness control. The scan line resistance R(1) is connected to the scan line selection circuit 19 shown in FIG. 1. In the connection point between the electron emitter and the scan line, the relationship of the following formula (1) works out.

$$\begin{matrix}I ( m ) = i ( m ) + I ( m + 1 ) & m = 1 through n - 1 \\ I ( m ) = i ( m ) & m = n\end{matrix} \qquad ( 1 )$$

When performing addition sequentially from the i(n), I(m) is obtained by the following formula (2).

$$I ( m ) = {\sum }_{p = m}^{n} i ( p ) \qquad ( 2 )$$

Further, in the connection point between the adjacent electron emitter and the scan line, the relationship of the following formula (3) works out.

$$V ( m ) - r ( m ) \cdot i ( m ) = V ( m - 1 ) - r ( m - 1 ) \cdot i ( m - 1 ) + R ( m ) \cdot I ( m ) \\ m = 2 through n \\ V ( m ) - r ( m ) \cdot i ( m ) = R ( m ) \cdot I ( m ) \\ m = 1 \qquad ( 3 )$$

Assuming that the R(1) through R(n) are all equal to R, when performing addition sequentially from the left hand in the formula (3) described above, the following formula (4) can be obtained.

$$V ( m ) = R {\sum }_{s = 1}^{m} I ( s ) + r ( m ) \cdot i ( m ) \qquad ( 4 )$$

When substituting the formula (2) described above for the corresponding part of the formula (4), the application voltage V(m) to the respective electron emitters is obtained by the following formula (5).

$$V ( m ) = R \cdot {\sum }_{s = 1}^{m} [ {\sum }_{p = s}^{n} i ( p ) ] + r ( m ) \cdot i ( m ) \qquad ( 5 )$$

The first term of the right-hand side of the formula (5) corresponds to the voltage drop amount caused by the scan line resistance, and the second term corresponds to the voltage between the both ends of the electron emitter. By executing the reverse correction of the voltage drop amount of the first term of the right-hand side of the formula (5) by the voltage drop amount calculation circuit 8 shown in FIG. 1, the output voltage of the signal line drive circuit 15 shown in FIG. 1 is determined. According to the method described above, the correction of the smear caused by the scan line resistance is realized.

Further, in the case of executing the ABL operation, by applying the current value obtained after altering the drive voltage in the drive voltage alteration amount calculation circuit 1 shown in FIG. 1 to the current i(m) flowing through the electron emitter in the second term of the right-hand side of the formula (5), the smear correction in the ABL operation is realized.

According to the present embodiment, in the case in which the ABL control is applied to the matrix type display using the electron emitters, optimization of the smear correction amount to the voltage drop by the scan line resistance can be achieved, thus the preferable image display without a smear can be realized.

Although the thin film electron source is cited as the example of the present invention, it is obvious that present invention is also effective for the display devices using other cathode elements such as field-emission cathode elements or carbon nanotube cathode elements.

What is claimed is:

1. A display device comprising:
a display panel including
a plurality of scan lines parallel to each other,
a plurality of signal lines perpendicular to the plurality of scan lines,
a plurality of electron emitters disposed respectively at intersections between the scan lines and the signal lines, and
a fluorescent material for emitting light responsive to electrons emitted from the electron emitters;
a scan line selection section for applying a selection voltage to the scan lines;
a scan voltage correction section for correcting a scan voltage to be supplied to the scan line selection section;
a voltage drop correction section for calculating an influence of the voltage drop caused by at least one of a resistance of the scan line and a resistance of the scan line selection section;
a signal line drive section for driving the signal lines based on signal voltage data from the voltage drop correction section;
a high voltage generation section for collecting the electrons emitted from the electron emitters to irradiate the fluorescent material;
a high voltage load current detection section for detecting a high voltage load current supplied from the high voltage generation section to the display panel; and
a high voltage load current limiting section for limiting the high voltage load current based on a high voltage load current detection signal from the high voltage load current detection section,
wherein the high voltage load current limiting section includes
a current reduction rate calculation section for calculating a current reduction rate at which a current flowing through the electron emitters is reduced in accordance with the high voltage load current detection signal, and
a drive voltage alteration amount calculating section for calculating drive voltage alteration data in accordance with the current reduction rate,
the scan voltage correction section outputs the scan voltage based on the drive voltage alteration data to the scan line selection section, and
the voltage drop correction section outputs the signal voltage data based on the drive voltage alteration data to the signal line drive section.

2. The display device according to claim 1,
wherein the voltage drop correction section includes
a subtracting section for subtracting the drive voltage alteration data form drive voltage data generated from image data input to the display device, and
a voltage drop amount calculation circuit for calculating voltage drop correction amount using drive voltage data from the subtracting section.
